(19) United States
(12) Patent Application Publication
(10) Pub. No.: US 2016/0233938 A1
(43) Pub. Date: Aug. 11, 2016

(54) Multiple Restrictions For CSI Reporting

(71) Applicant: Nokia Solutions and Networks Oy, Espoo (FI)

(72) Inventors: Bishwarup Mondal, Beavercreek, IL (US); Xiaoyi Wang, Hoffman Estates, IL (US); Eugene Visotsky, Buffalo Grove, IL (US)

(73) Assignee: Nokia Solutions and Networks Oy

(21) Appl. No.: 14/615,694

(22) Filed: Feb. 6, 2015

(51) Int. Cl. H04B 7/06; H04B 17/345; H04W 72/04; H04B 7/04

(52) U.S. Cl. CPC H04B 7/0626; H04B 7/0417; H04B 17/345; H04B 7/0456; H04W 72/0453; H04W 72/0446

(57) ABSTRACT

A UE is configured with restrictions that restrict resources carrying RSs and IMRs to specific resources to be used by the UE for determining CSI. The restrictions are both of the following: first restrictions in time, frequency, or both time and frequency of resources that carry the reference signals; and second restrictions in time, frequency, or both time and frequency of resources that carry the interference measurement resources. The RSs and IMRs are transmitted by a base station to and received by the UE. The UE determines the CSI based on the specific resources for the RSs and IMRs. The CSI, determined based on the RS, IMRs, and the restrictions, is received from and transmitted by the UE. The base station uses the CSI for a MU-MIMO transmission. Apparatus, methods, computer software, and program products are disclosed.

### TECHNICAL FIELD

This invention relates generally to wireless communications and, more specifically, relates to channel state information (CSI) feedback for communication systems using many antennas.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section. Abbreviations that may be found in the specification and/or the drawing figures are defined below, prior to the claims.

Multiple-antenna (e.g., MIMO) technology is becoming mature for wireless communications and has been incorporated into wireless broadband standards like LTE and Wi-Fi. Basically, the more antennas the transmitter/receiver is equipped with, the more the possible signal paths and the better the performance in terms of data rate and link reliability. The price to pay is increased complexity of the hardware (e.g., the number of RF amplifier frontends) and the complexity and energy consumption of the signal processing at both ends.

Massive MIMO uses a very large number of service antennas (e.g., hundreds or thousands) that are operated fully coherently and adaptively. Extra antennas help by focusing the transmission and reception of signal energy into ever-smaller regions of space. This brings improvements in throughput and energy efficiency, in particularly when combined with simultaneous scheduling of a large number of user equipment (e.g., tens or hundreds).

While massive MIMO has benefits, it also has drawbacks, particularly for CSI measurement and reporting.

### BRIEF SUMMARY

This section is intended to include examples and is not intended to be limiting.

An exemplary method includes configuring a user equipment with restrictions that restrict resources carrying reference signals and interference measurement resources to specific resources to be used by the user equipment for determining channel state information. The restrictions are both of the following: first restrictions in time, frequency, or both time and frequency of resources that carry the reference signals; and second restrictions in time, frequency, or both time and frequency of resources that carry the interference measurement resources. The method includes transmitting the reference signals and interference measurement resources to the user equipment, and receiving from the user equipment the channel state information determined based on the reference signals, interference measurement resources, and the restrictions.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An apparatus comprises: means for configuring a user equipment with restrictions that restrict resources carrying reference signals and interference measurement resources to specific resources to be used by the user equipment for determining channel state information, wherein the restrictions are both of the following: first restrictions in time, frequency, or both time and frequency of resources that carry the reference signals; and second restrictions in time, frequency, or both time and frequency of resources that carry the interference measurement resources; means for transmitting the reference signals and interference measurement resources to the user equipment; and means for receiving from the user equipment the channel state information determined based on the reference signals, interference measurement resources, and the restrictions.

An exemplary apparatus includes one or more processors and one or more memories including computer program code. The one or more memories and the computer program code are configured to, with the one or more processors, cause the apparatus to perform at least the following: configuring a user equipment with restrictions that restrict resources carrying reference signals and interference measurement resources to specific resources to be used by the user equipment for determining channel state information, wherein the restrictions are both of the following: first restrictions in time, frequency, or both time and frequency of resources that carry the reference signals; and second restrictions in time, frequency, or both time and frequency of resources that carry the interference measurement resources; transmitting the reference signals and interference measurement resources to the user equipment; and receiving from the user equipment the channel state information determined based on the reference signals, interference measurement resources, and the restrictions.

An exemplary computer program product includes a computer-readable storage medium bearing computer program code embodied therein for use with a computer. The computer program code includes: code for configuring a user equipment with restrictions that restrict resources carrying reference signals and interference measurement resources to specific resources to be used by the user equipment for determining channel state information, wherein the restrictions are both of the following: first restrictions in time, frequency, or both time and frequency of resources that carry the reference signals; and second restrictions in time, frequency, or both time and frequency of resources that carry the interference measurement resources; code for transmitting the reference signals and interference measurement resources to the user equipment; and code for receiving from the user equipment the channel state information determined based on the reference signals, interference measurement resources, and the restrictions.

In another exemplary embodiment, a method includes configuring a user equipment with restrictions that restrict resources carrying reference signals and interference measurement resources to specific resources to be used by the user equipment for determining channel state information. The restrictions are both of the following: first restrictions in time, frequency, or both time and frequency of resources that carry the reference signals; and second restrictions in time, frequency, or both time and frequency of resources that carry the interference measurement resources. The method includes receiving from a base station the reference signals and interference measurement resources, determining the channel state information based on the specific resources for the reference signals and interference measurement resources, and transmitting the channel state information to the base station.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

In a further exemplary embodiment, an apparatus comprises: means for configuring a user equipment with restrictions that restrict resources carrying reference signals and interference measurement resources to specific resources to be used by the user equipment for determining channel state information, wherein the restrictions are both of the following: first restrictions in time, frequency, or both time and frequency of resources that carry the reference signals; and second restrictions in time, frequency, or both time and frequency of resources that carry the interference measurement resources; means for receiving from a base station the reference signals and interference measurement resources; means for determining the channel state information based on the specific resources for the reference signals and interference measurement resources; and means for transmitting the channel state information to the base station.

An exemplary apparatus includes one or more processors and one or more memories including computer program code. The one or more memories and the computer program code are configured to, with the one or more processors, cause the apparatus to perform at least the following: configuring a user equipment with restrictions that restrict resources carrying reference signals and interference measurement resources to specific resources to be used by the user equipment for determining channel state information, wherein the restrictions are both of the following: first restrictions in time, frequency, or both time and frequency of resources that carry the reference signals; and second restrictions in time, frequency, or both time and frequency of resources that carry the interference measurement resources; receiving from a base station the reference signals and interference measurement resources; determining the channel state information based on the specific resources for the reference signals and interference measurement resources; and transmitting the channel state information to the base station.

An exemplary computer program product includes a computer-readable storage medium bearing computer program code embodied therein for use with a computer. The computer program code includes: code for configuring a user equipment with restrictions that restrict resources carrying reference signals and interference measurement resources to specific resources to be used by the user equipment for determining channel state information, wherein the restrictions are both of the following: first restrictions in time, frequency, or both time and frequency of resources that carry the reference signals; and second restrictions in time, frequency, or both time and frequency of resources that carry the interference measurement resources; code for receiving from a base station the reference signals and interference measurement resources; code for determining the channel state information based on the specific resources for the reference signals and interference measurement resources; and code for transmitting the channel state information to the base station.

### BRIEF DESCRIPTION OF THE DRAWINGS

In the attached Drawing Figures:

FIG. 1 is a block diagram of an exemplary system in which the exemplary embodiments may be practiced;

FIG. 2 is an example of scheduling details in an exemplary embodiment;

FIG. 3 is a logic flow diagram performed by a base station and FIG. 4 is a logic flow diagram performed by a user equipment for multiple restrictions for CSI reporting, and these figures illustrate the operation of an exemplary method, a result of execution of computer program instructions embodied on a computer readable memory, functions performed by logic implemented in hardware, and/or interconnected means for performing functions in accordance with exemplary embodiments; and

FIG. 5 is an example of IMR restriction;

FIG. 6 is an example of how multiple CSI processes, each with restricted measurements for CSI-RS and IMR, could co-exist in a subframe and then switch positions in the next sub-frame;

FIG. 7 is an example of an information element in one exemplary. embodiment; and

FIG. 8 is a logic flow diagram performed by a base station and FIG. 9 is a logic flow diagram performed by a user equipment for multiple restrictions for CSI reporting, and these figures illustrate the operation of an exemplary method, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

The exemplary embodiments herein describe techniques for multiple measurement restrictions for CSI reporting, such as CQI and rank reporting. Additional description of these techniques is presented after a system in which the exemplary embodiments may be used is described.

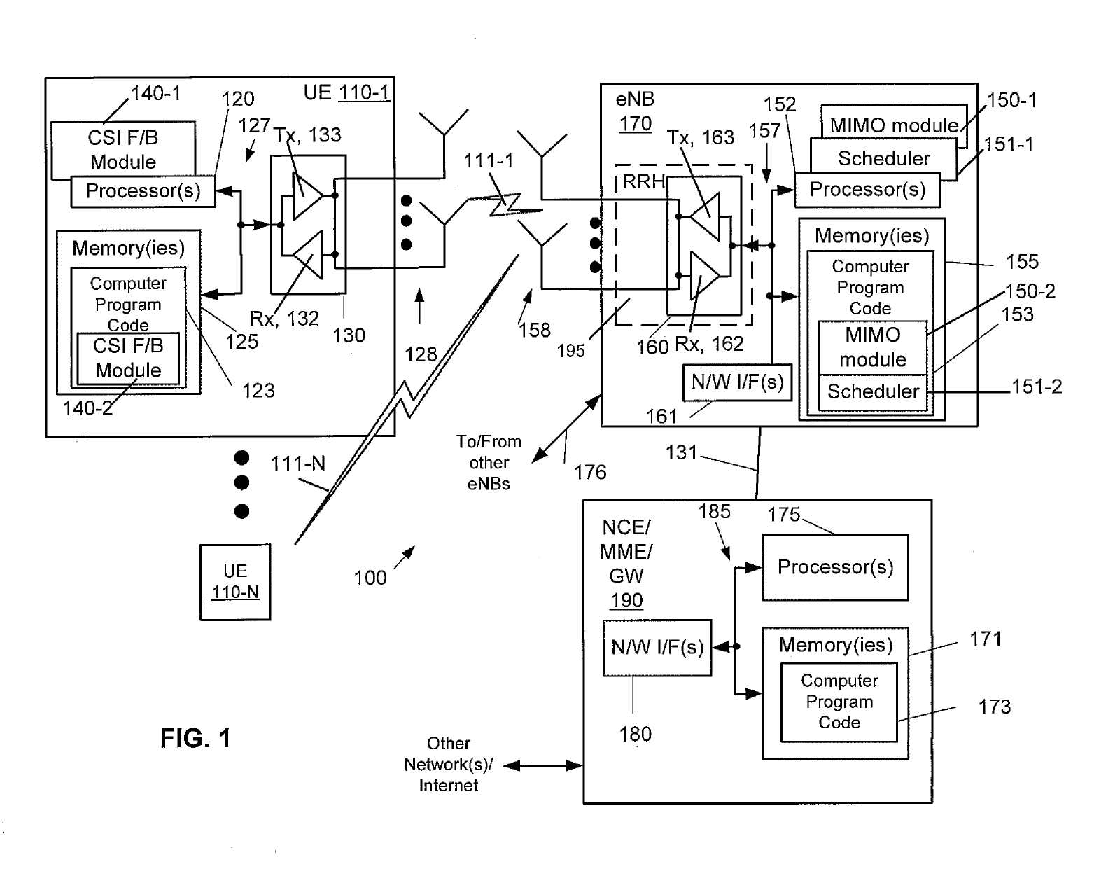

Turning to FIG. 1, this figure shows a block diagram of an exemplary system in which the exemplary embodiments may be practiced. In FIG. 1, N UEs 110-1 through 110-N are in wireless communication with a wireless network 100. It is assumed the UEs 110 are similar and only UE 110-1 will be discussed herein. The user equipment 110 (e.g., UE 110-1) includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a CSI F/B (feedback) module 140, comprising one of or both parts 140-1 and/or 140-2, which may be implemented in a number of ways. The CSI F/B module 140 may be implemented in hardware as CSI F/B module 140-1, such as being implemented as part of the one or more processors 120. The CSI F/B (feedback) module 140-1 may be implemented also as an integrated circuit or through other hardware such as a programmable gate array. In another example, the CSI F/B module 140 may be implemented as CSI F/B module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. Each UE 110 communicates with eNB 170 via a wireless link 111, and there are N wireless links shown.

The eNB 170 is a base station that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to multiple (e.g., many) antennas 158. The antennas may be a 3D planar antenna structure, where each column is a cross-polarized array, for instance. The one or more memories 155 include computer program code 153. The eNB 170 includes a MIMO module 150, comprising one of or both parts 150-1 and/or 150-2, and the scheduler 151, both of which may be implemented in a number of ways. The MIMO module 150 and/or the scheduler 151 may be implemented in hardware as MIMO module 150-1 or as the scheduler 151-1, respectively, such as being implemented as part of the one or more processors 152. The MIMO module 150 and/or the scheduler 150 may be implemented also as an integrated circuit or through other hardware such as a programmable gate array. In another example, the MIMO module 150 or the scheduler 151 may be implemented as MIMO module 150-2 or scheduler 151-2, respectively, which are implemented as computer program code 153 and are executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. The scheduler 151 performs operations such as scheduling communications between the eNB 170 and the UEs 110. The MIMO module 150 performs operations such as communicating between the eNB 170 and the UEs 110 using (e.g., massive) MIMO, which uses many antennas, such as SU-MIMO or MU-MIMO. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME/SGW functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Now that one possible system has been discussed, problems with massive MIMO are discussed. It is well recognized that with massive MIMO, in the context of reciprocity-based operation, the prediction of accurate MCS and rank is the bottleneck for performance. Note that the determination of a precoder can be performed in certain cases with good accuracy (for example, with multiple transmit antennas at the UE) and is not a bottleneck for performance. It is also well recognized that in the case of massive MIMO, MU-MIMO transmission is critical and the challenge here is to estimate the interference due to co-scheduled UEs. That is, UE1 co-scheduled with UE2 means that both UEs are sharing a common time-frequency resource as well as Tx power when receiving data from the eNB. They receive transmission from the same eNB on the same time-frequency resource but utilizing two different precoders. These transmissions interfere with each other depending on the precoders and the channel.

Furthermore, CATT contribution R1-144948 and Intel contribution R1-144670 proposed to use beamformed CSI-RS transmission for massive MIMO. These contributions were introduced at 3GPP TSG-RAN WGI #79, November 2014. While these contributions have possible benefits, they still have the possibility of having precoding weights that can change rather quickly (e.g., dynamically) both in time and in frequency.

Rel-10 eICIC introduced a subframe subset concept, which can be considered as a type of measurement restriction. An introduction to this concept is provided in Pedersen, et al., “eICIC functionality and performance for LTE HetNet co-channel deployments”, Vehicular Technology Conference (VTC Fall), 2012 IEEE. IEEE Press, 2012. The Pedersen article states the following: “It is therefore necessary for the network to configure restricted CSI measurements for Rel-10 UEs, so that the eNB receives such reports corresponding to normal subframes and ABS, respectively.” That is, CSI measurements may be restricted to either normal subframes or ABSs. By contrast, in the instant embodiments, signal and interference for one CQI report (as an example) may follow different restrictions for time and/or frequency, as described below.

Exemplary embodiments herein relate to massive MIMO systems, e.g., to be deployed in 5G as well as future FD-MIMO LTE-A systems in Rel-13 and beyond. Focus is placed on the design aspects on 3D-MIMO, especially channel state information (CSI) feedback.

Channel reciprocity is one key feature of a TDD system, where an estimated channel from uplink could be used to form the beamforming precoder for a downlink transmission. It is especially interesting in a massive MIMO environment, with a large number of antenna ports, since codebook-based PMI feedback amount is too high.

In this document, exemplary solutions are proposed that are applicable to the problems noted above. Specifically, in an example, a proposal is to use measurement restrictions for CSI measurement that will enable the eNB to use UE-specific precoded CSI-RS (e.g., CSI measurement resources) for accurate MCS and rank selection for data transmission. In addition, as another example, it is proposed to use UE-specific IMRs (interference measurement resources) that are resource restricted to enable estimation of interference due to co-scheduled MU-MIMO UEs for enhancing MU-MIMO transmission. Furthermore, measurement restrictions are proposed in embodiments to be defined for CQI and RI feedback to allow for CSI-based beamforming without requiring PMI feedback.

A motivation for the exemplary embodiments herein is a need for CQI and RI feedback using precoded CSI-RS (e.g., CSI measurement resource) and in conjunction with IMRs for MU-MIMO purposes. That is, since an appropriate precoding weight can change rather quickly (e.g., dynamically) both in time and in frequency, it is necessary that a UE does not average the measurements obtained from CSI-RS or IMR instances in an unrestricted fashion in time or frequency or both. Therefore it is beneficial to have restrictions on how much a UE can average in time, frequency, or both while measuring multiple instances of precoded CSI-RS and IMR.

In this instance, since there is no need for PMI feedback, the accuracy requirement of channel estimation and interference estimation is reduced. In other words, the accuracy requirement of channel and interference estimation can be relaxed to a certain extent because the UE is not required to feedback a PMI in this case. Rank in this case is defined in an open loop sense of comparing single-port transmission with two-port transmission (with no PMI). On the other hand, due to the UE-specific nature of CSI-RS and IMR needed in this case, there is a need for more physical resources to be dedicated to CSI-RS and IMR within a serving cell, relative to without using UE-specific CSI-RS and UE-specific IMR. This is because UE-specific CSI-RS and IMR will be used, e.g., for multiple UEs, and this UE-specific CSI-RS and IMR is not used in a conventional system.

This invention, in an exemplary embodiment, allows one to configure separately measurement restrictions in time and/or frequency for CSI-RS resources and IMR. The accuracy of CQI, RI is expected to be not affected significantly, especially as more measurement samples become available to the UE as time progresses. Measurement restriction can be configured by the network (e.g., via the eNB 170) and the UE 110 shall separately measure the signal and interference part following each measurement restriction.

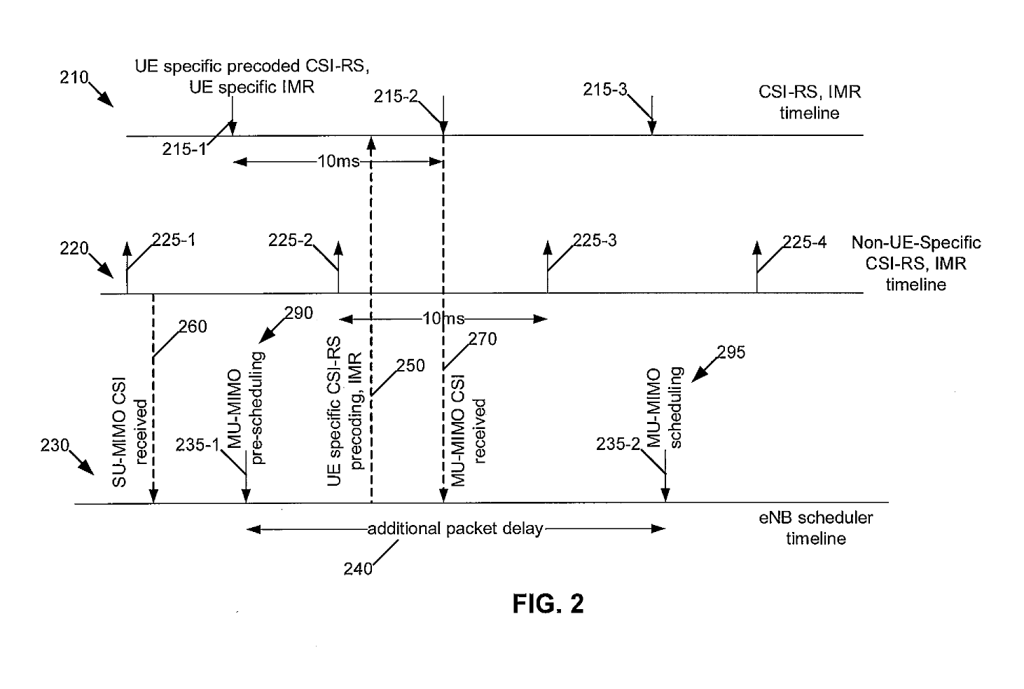

Exemplary scheduling details for MU-MIMO is detailed in FIG. 2, where it is shown how UE-specific precoded CSI-RS and UE-specific IMR can be utilized for accurate link adaption for MU-MIMO by incorporating some additional packet delay at the scheduler. A precoded CSI-RS along with a measurement restriction is considered to be UE-specific if the physical resources for the precoded CSI-RS with such a restriction are dedicated for a particular UE—this is a provisioning issue at the eNB 170. The same rule applies to a UE-specific IMR. The UE does not know if some other UE is also measuring on the same resource. Other than this provisioning aspect, there is no unique property of a CSI-RS that makes it UE specific.

FIG. 2 shows a CSI-RS, IMR timeline 210 at the eNB 170, such that UE-specific CSI-RS and IMR precoding are transmitted by eNB 170 at times 215-1, 215-2, and 215-3. FIG. 2 also shows a non-UE-specific CSI-RS, IMR timeline 220, illustrating times 225-1, 225-2, 225-3, and 225-4 when the eNB 170 transmits the non-UE-specific CSI-RS, IMR. The eNB scheduler timeline 230 shows a time 260 at which a SU-MIMO CSI is received in response to the non-UE-specific CSI-RS, IMR transmitted by the eNB 170 at time 225-1. For ease of reference, the other receptions by the eNB 170 in response to the times 225-2 through 225-4 are not shown. MU-MIMO prescheduling occurs at time 235-1 and the MU-MIMO scheduling occurs at time 235-2. The additional packet delay 240 is also shown. Furthermore, at time 250, the eNB transmits UE-specific CSI-RS that is precoded using a precoder intended for UE 110 and UE-specific IMR intended for UE110. At time 250, the eNB also transmits precoded signals using a precoder not intended for UE110 on a resource that coincides with the UE specific IMR intended for UE110. It is noted that CSI-RS is a signal that is measured at the UE 110. IMR, on the other hand, is not a signal but a time-frequency-resource, and the UE 110 measures the power on the designated IMR and assumes that this is the interference power. The UE 110 responds at time 215-2 with transmission of MU-MIMO CSI, which is received by the eNB 170 at time 270. The MU-MIMO CSI reflects the signal to interference plus noise ratio (SINR) corresponding to a MU-MIMO transmission to UE 110. It may be noted that UE 110 may assume a SU-MIMO hypothesis for determining CSI transmitted at 215-2.

A typical, exemplary process is now described. A UE 110 is configured with a CSI-process-1 that is comprised of a CSI-RS and an IMR. This CSI-RS and IMR is not precoded, is not UE specific, and has no measurement restrictions associated with the CSI-RS or the IMR (or the process may have a measurement restriction on IMR). This is represented by the timeline 220. The UE provides CSI feedback (e.g., CQI/RI/PMI feedback) according to this CSI-process every 10 ms, as illustrated by times 225.

The same UE 110 is also configured with another CSI-process-2 that is comprised of a UE-specific precoded CSI-RS with measurement restrictions and a UE-specific IMR with measurement restrictions. This is represented by the timeline 210. The UE provides CQI feedback according to this CSI-process every 10 ms, as illustrated by the times 215.

The scheduling timeline at the eNB is represented by the timeline 230. The eNB 170 considers the CSI (e.g., CQI/PMI/RI reports) received due to CSI-process-1 (SU-MIMO CSI in the figure) and determines the best MU-MIMO pairing for the UE (MU-MIMO pre-scheduling 290 in the figure). At the same time, the eNB 170 determines the precoding weight for the UE to be used for MU transmission as well as the precoding weight for a paired UE. Once this is done, the eNB 170 is able to precode a CSI-RS and an IMR with the determined precoding weights as needed by CSI-process-2 and transmits the same at time 250. The eNB uses the precoding weight determined for the UE for precoding the CSI-RS and uses the precoding weight determined for the paired UE for precoding the IMR. The eNB 170 then receives a CQI associated with CSI-process-2 from the UE (at time 270) and proceeds to data transmission (MU-MIMO scheduling 295 in the figure). The additional packet delay 240 in scheduling at least for certain scheduling instances (may not be all) is unique to embodiments herein.

Note that there is an improvement of link adaptation for MU-MIMO by enabling accurate estimation of interference from co-scheduled UEs. That is, if the CSI-process-2 does not exist, which can be considered as the conventional way of scheduling, then the PMI fed back by the UE is modified by the eNB due to MU transmission and the interference observed by the UE in CSI-process-1 does not include the interference due to the paired UE. Both of these reasons result in poor link adaptation performance. Due to the additional CSI-process-2, the eNB can actually create a somewhat dummy MU transmission via CSI-process-2 and expect an accurate CQI that can be used for the actual data transmission with exactly the same precoding weights used for precoding the CSI-process-2. In more detail, when a UE receives data due to a MU (multi-user) transmission, another UE is also receiving data on the same resources as well as taking up one-half the power (assuming a pairing of two UEs). When the UE estimates CSI using CSI-process-1, the UE does not assume a MU transmission but instead assumes a SU (single-user) transmission where there are no co-scheduled UEs and transmission happens with full power. Therefore, the estimated CSI using CSI-process-1 does not help the eNB 170 enough to perform an efficient MU transmission (e.g., as the eNB cannot select proper MCS). The CSI-process-2 assigns one-half power to the UE (for a pairing of two UEs) and the process also emulates the interference due to the co-scheduled UE in the IMR resources—this is exactly how the UE would perceive a MU transmission and the CSI determined from CSI-process-2 then helps the eNB to perform an efficient MU transmission (e.g., as the eNB can select proper MCS).

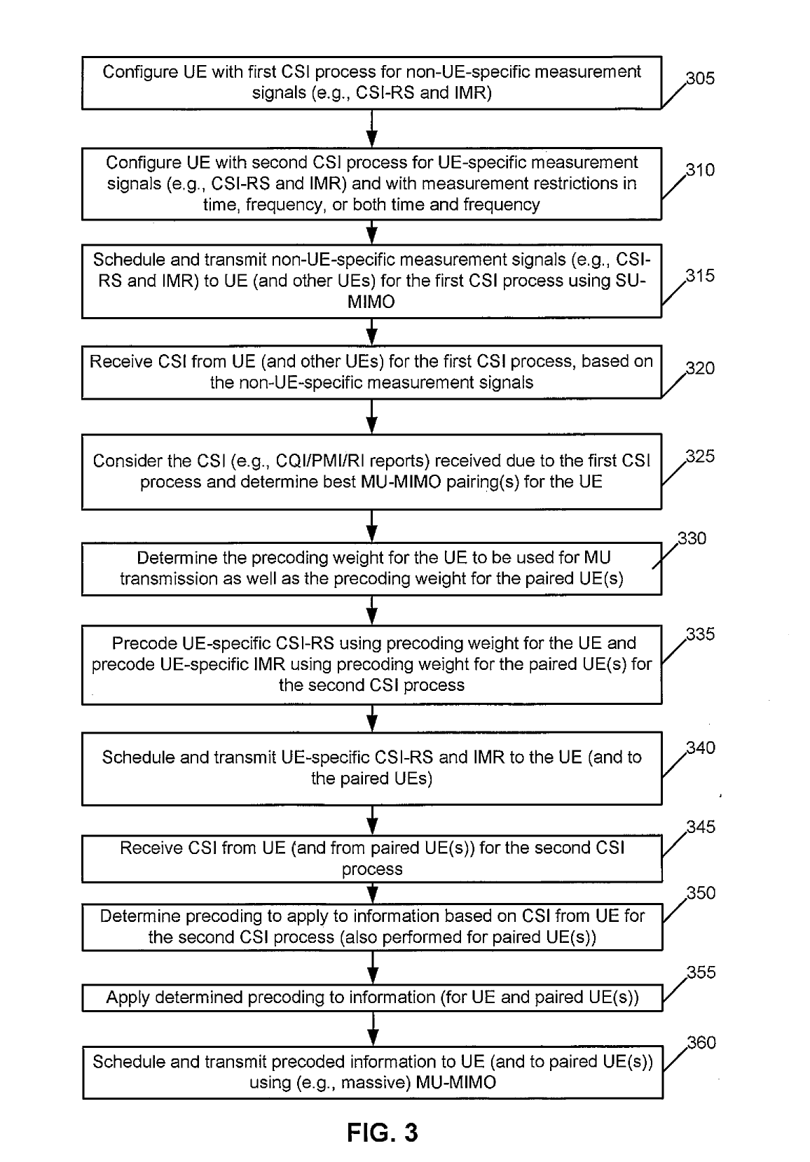

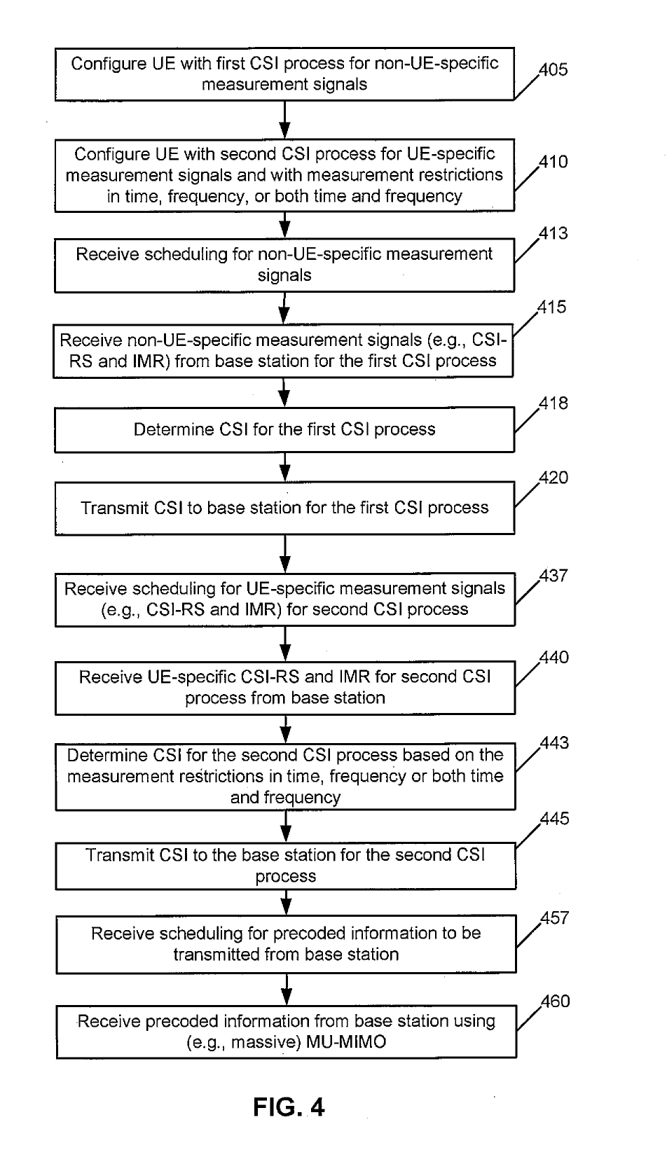

Now that an example of scheduling has been described, more detailed flows for the eNB 170 and UE 110 are described in relation to FIGS. 2-4. FIG. 3 is a logic flow diagram performed by a base station and FIG. 4 is a logic flow diagram performed by a user equipment for multiple measurement restrictions for CSI reporting. These figures illustrate the operation of an exemplary method, a result of execution of computer program instructions embodied on a computer readable memory, functions performed by logic implemented in hardware, and/or interconnected means for performing functions in accordance with exemplary embodiments. The operations performed by the eNB 170 may be performed under the control in part of the scheduler 151, and the operations performed by the eNB 170 for MIMO transmissions and receptions may be performed under the control in party of the MIMO module 150. The UE 110 may be considered to perform the blocks in FIG. 4, e.g., under control in part by the CSI F/B module 140.

In blocks 305 and 405, the eNB 170 configures the UE 110 (and the UE configures itself in block 405) with the first CSI process for non-UE-specific measurement signals such as CSI-RS and IMR. As stated above, there are no measurement restrictions associated with the CSI-RS or the IMR (or the process may have a measurement restriction on IMR) for blocks 305 and 405. In blocks 310 and 410, the eNB 170 configures the UE 110 (and the UE 110 configures itself for block 410) with a second CSI process for UE-specific measurement signals (such as CSI-RS and IMR) and with measurement restrictions in time, frequency, or both time and frequency. The measurement restrictions configure the UE 110 with one or more restrictions that restrict resources carrying reference signals (e.g., CSI-RS) and IMRs to specific resources to be used by the UE 110 for determining channel state information. The one or more restrictions are one or both of the following: restrictions in time, frequency, or both time and frequency of resources that carry the reference signals; and/or restrictions in time, frequency, or both time and frequency of resources that carry the interference measurement resources.

In block 315, the eNB schedules and transmits non-UE-specific measurement signals (e.g., CSI-RS and IMR) to the UE 110 (and other UEs 110) for the first CSI process using SU-MIMO. This corresponds to blocks 413 and 415, where the UE 110 receives scheduling for the non-UE-specific measurement signals (block 413) and then receives corresponding non-UE-specific measurement signals (e.g., CSI-RS and IMR) from the base station for the first CSI process (block 415). This is illustrated in FIG. 2 at the time 225, where the eNB transmits the non-UE-specific CSI-RS and IMR.

In block 418, the UE 110 determines CSI (such as CQI/RI/PMI) for the first CSI process and in block 420 transmits the CSI to the base station for the first CSI process. This CSI is based on the received non-UE-specific measurement signals. Note that the non-UE-specific IMR (for CSI-process-1) does not reflect the interference condition for MU. The eNB 170 receives the CSI from the UE (and other UEs) for the first CSI process in block 320. This is illustrated in FIG. 2 by the time 260, where the SU-MIMO CSI is received.

In block 325, the eNB considers the CSI (e.g., CQI/PMI/RI reports) received due to the first CSI process and determines best MU-MIMO pairing(s) for the UE, where another UE is (or other UEs are) paired with the original UE. The pairing means that the original UE (e.g., UE 110-1) and the other UE(s) (e.g., UEs 110-2 . . . ) will be part of a MU transmission. The MU-MIMO pre-scheduling 290 in FIG. 2 includes at least the determining the best MU-MIMO pairing(s) for the UE. In block 330, the eNB 170 determines the precoding weight for the UE to be used for MU transmission as well as the precoding weight for the paired UE(s). These determinations are based on the CSI from the UE and the paired UE(s).

The eNB 170 then, in block 335, precodes UE-specific CSI-RS using the precoding weight for the UE and precodes UE-specific IMR using the precoding weight for the paired UE(s) for the second CSI process. In terms of precoding UE-specific IMR, for the original UE, this UE is configured to measure the UE-specific resource(s) carrying the IMR, based on the configured measurement restrictions. From the perspective of the original UE, the UE-specific IMR is simply a resource (or resources) with restrictions on which resources will be used to determine CSI. From the perspective of the eNB, a precoding transmission coincides on the same resource as the IMR, the precoder(s) being designed for the paired UE(s). The transmission could be a “dummy” one, intended simply for the purposes of emulating the interference. The transmission also could also be a valid transmission to the paired UE(s), including a reference signal. In block 340, the eNB 170 schedules and transmits the UE-specific measurement signals, the precoded CSI-RS and IMR, to the UE and may also transmit to the paired UE(s) at the same time. This is illustrated in FIG. 2 at time 250, where UE-specific CSI-RS and IMR are transmitted by the eNB 170. Block 340 corresponds to blocks 437 and 440. The UE 110, in block 437, receives scheduling for the UE-specific measurement signals for second CSI process, and in block 440 receives the UE-specific CSI-RS and IMR for the second CSI process from the base station. As described above, from the perspective of the original UE, the UE-specific IMR is simply a resource (or resources) with restrictions on which resources will be used to determine CSI. From the perspective(s) of the paired UE(s), a precoded transmission coincides on the same resource as the IMR, the precoder(s) designed for the paired UE(s).

The UE 110 in block 443 determines CSI for the second CSI process based on the measurement restrictions in time, frequency or both time and frequency. That is, the UE uses the configured one or more restrictions that restrict resources carrying reference signals (e.g., CSI-RS) and IMRs to specific resources to be used by the UE for determining the CSI. This CSI is typically CQI and/or RI. Note that the reference signals and IMRs can be independently configured. Measurement restrictions could be a set of {subcarriers or PRBs or subbands, sub-frames}, e.g., that occur every frame (10 ms), e.g., {subband 0, sub-frames 4/10, 5/10} occurring every frame. Measurement restrictions could also be a function of sub-frame number and thereby change with time (e.g., by cycling through a set of restrictions). Measurement restrictions should be consistent with the signaled configurations for CSI-RS and IMR. That is, the UE should not be forced to measure at a particular resource where the UE does not expect to receive the CSI-RS signal or IMR.

In block 445, the UE 110 transmits the determined CSI to the base station for the second CSI process. In FIG. 2, this is illustrated at times 215 and specifically 215-2. The eNB 170 in block 345 receives the CSI from UE (and from the paired UE(s)) for the second CSI process, and this is illustrated in FIG. 2 at time 270, where MU-MIMO CSI is received.

In block 350, the eNB 170 determines precoding to apply to information based on the CSI from UE for the second CSI process. This operation is similarly performed for the paired UE(s). In block 355, the eNB 170 applies the determined precoding to the information and schedules and transmits the precoded information to the UE (and to the paired UE(s)) using (e.g., massive) MU-MIMO in block 360. The scheduling and transmitting is illustrated in FIG. 2 at time 235-2, by the MU-MIMO scheduling 295. Block 360 corresponds to blocks 457 and 460, where the UE 110 receives scheduling for the precoded information to be transmitted from base station (block 457) and receives precoded information from the base station using (e.g., massive) MU-MIMO.

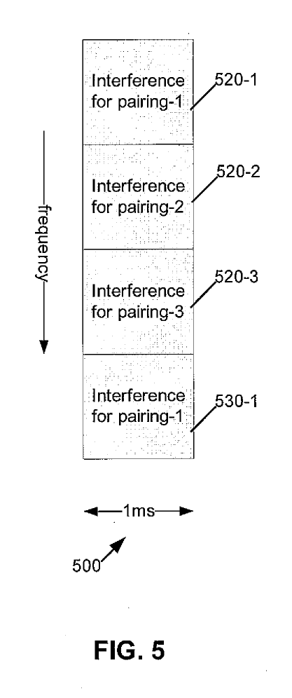

To clarify how the restriction of the UE-specific precoded CSI-RS and IMR may look in practice, FIG. 5 presents an example of IMR measurement restriction. A similar example could be used for CSI-RS. In a given sub-frame 500, the IMR resources are partitioned in frequency. In different sub-bands, different interference is composed by the eNB that corresponds to different MU-MIMO pairings. The UE is not expected to average interference across sub-bands but is allowed to average interference across different sub-frames 500. In this example, the entire bandwidth (shown as “frequency”) is divided into four sub-bands, of which sub-bands 520-1 and 530-1 correspond to interferences for a first UE pairing (pairing-1), sub-band 520-2 corresponds to interferences for a second UE pairing (pairing-2), and sub-band 520-3 corresponds to interferences for a third UE pairing (pairing-3). The measurement restriction CSI-RS may be similarly designed for frequency and time. In FIG. 5, the UE is using both sub-bands 520-1 and 530-1 for a single CSI calculation for the purposes of an exemplary embodiment-meaning at least one of the CSI components (e.g., rank) is determined based on both the sub-bands.

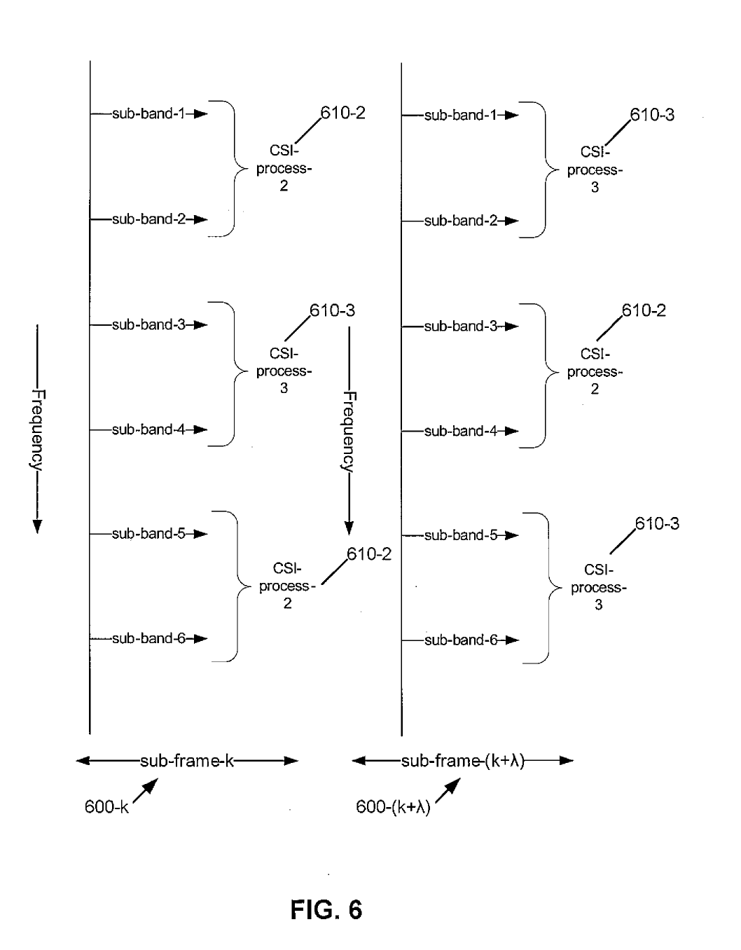

FIG. 6 shows an example of how multiple CSI processes, each with restricted measurements for CSI-RS and IMR, could co-exist in a subframe and then switch positions in the next sub-frame. This illustrates multiplexing of CSI processes in an FDM fashion for both periodic and aperiodic feedback reporting cases. As can be seen, sub-frame 600-k has CSI process-2 610-2 in sub-bands 1, 2, 5, and 6 and CSI process-3 610-3 in sub-bands 3 and 4. In a later (e.g., subsequent) subframe 600-(k+λ), the CSI process-2 610-2 is in sub-bands 3 and 4 and CSI process-3 610-3 is in sub-bands 1, 2, 5, and 6. A similar situation as in FIG. 5 applies to FIG. 6. For instance, the UE is using both sub-bands 610-2 for sub-frame 600-k for a single CSI calculation for the purposes of an exemplary embodiment—meaning at least one of the CSI components (e.g., rank) is determined based on both the sub-bands for this particular sub-frame. In FIG. 6, at least one of the restrictions will not span multiple sub-frames—e.g., the IMR may not span multiple subframes but the CSI-RS can.

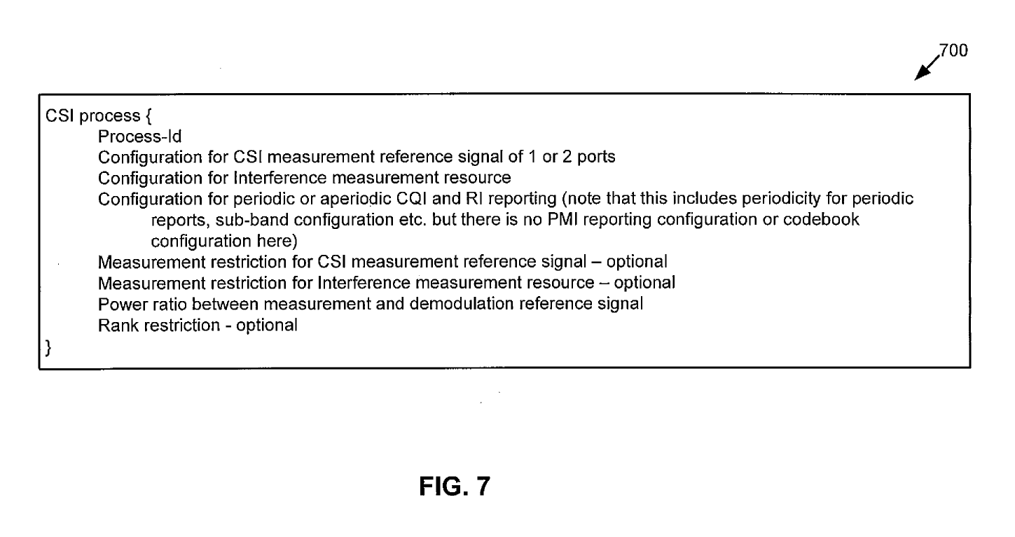

Communication of measurement restrictions from the eNB 170 to the UE 110 might be as follows. Resource restrictions could be communicated to a UE 110 in an explicit manner, e.g., exclusively via RRC signaling or a combination of RRC and dynamic signaling (dynamic selection of one resource restriction or rank restriction could be dynamic for example). An example information element 700 for RRC signaling of CSI process with resources restriction is shown in FIG. 7. FIG. 7 illustrates components of higher layer signaling.

Concerning UE behavior considering measurement restrictions, the following are examples of such. For CSI feedback, the UE 110 will recognize the resource restrictions when measuring CSI measurement REs or interference from IMRs that are configured by higher layer signaling. A UE, for purposes of determining CSI feedback, will not average across the measurement restrictions for the purposes of determining CQI and RI feedback. If a 1-port CSI-RS is configured then rank determination is not applicable. If a 2-port CS-RS is configured, then the UE may determine and feedback rank. It is also possible for the eNB to restrict the rank of an UE to 1 (one).

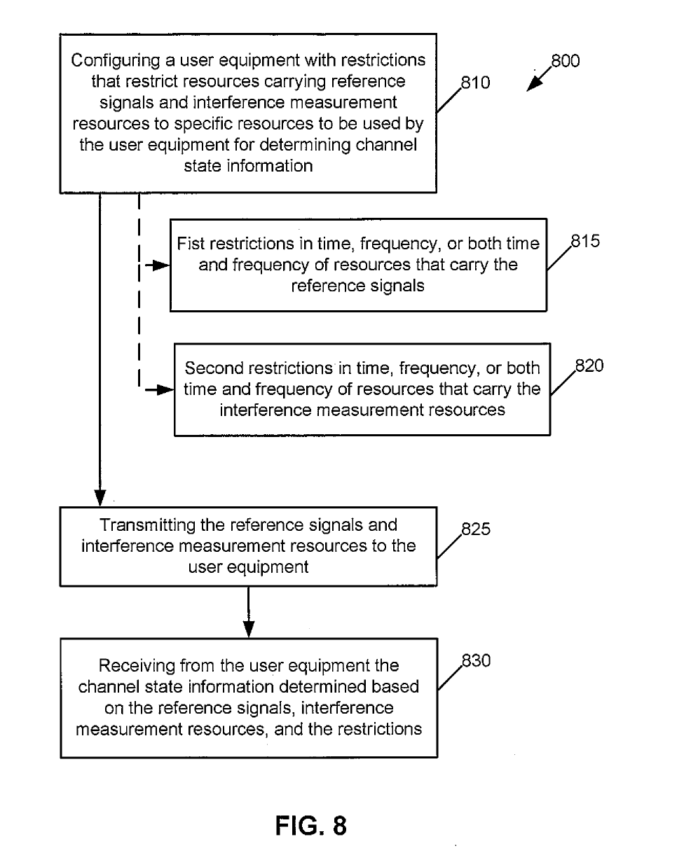

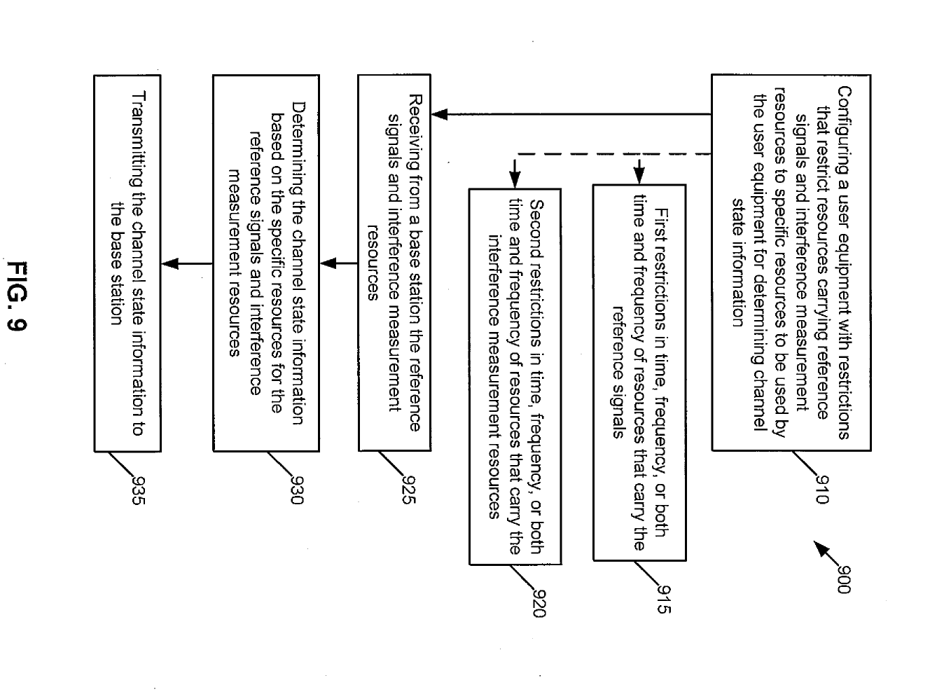

FIG. 8 is a logic flow diagram performed by a base station for multiple restrictions for CSI reporting. This figure illustrates the operation of an exemplary method, a result of execution of computer program instructions embodied on a computer readable memory, functions performed by logic implemented in hardware, and/or interconnected means for performing functions in accordance with exemplary embodiments. It is assumed the blocks in FIG. 8 are performed by a base station such as eNB 170, e.g., under control in part of the MIMO module 150 and scheduler 151.

For ease of reference, assume that the flow in FIG. 8 is a method 800. The eNB 170, as part of method 800, in block 810 performs the operation of configuring a user equipment with restrictions that restrict resources carrying reference signals and interference measurement resources to specific resources to be used by the user equipment for determining channel state information. The restrictions are both of the following: first restrictions in time, frequency, or both time and frequency of resources that carry the reference signals (block 815); and second restrictions in time, frequency, or both time and frequency of resources that carry the interference measurement resources (block 820). The first and second restrictions may be different. In block 825, the eNB 170 performs the operation of transmitting the reference signals and interference measurement resources to the user equipment. The eNB 170, in block 830, performs the operation of receiving from the user equipment the channel state information determined based on the reference signals, interference measurement resources, and the restrictions.

Additional exemplary embodiments are as follows. A method as in method 800, wherein the restrictions restrict specific resources to one of a set of subcarriers, a set of physical resource blocks, a set of subbands, or a set of sub-frames for one or both of the reference signals or the interference measurement resources. A method as in this paragraph, wherein the specific resources are further restricted to certain resources that occur during a frame.

A method as in method 800 and the previous paragraph, wherein the configuring further comprises configuring the user equipment to restricting use by the user equipment to the specific resources as a function of sub-frame number and changing the sub-frame number with time.

A method as in method 800 and paragraphs referencing method 800, wherein:

the method further comprises:

determining a pairing between the user equipment and one or more paired user equipment based on channel state information from the user equipment that was determined from non-user-equipment-specific reference signals and interference measurement resources and from a plurality of other user equipment including the one or more paired user equipment; and

precoding, using the determined pairing, user equipment-specific channel state information reference signals based on a precoding weight determined for the user equipment and precoded information to be transmitted on resources corresponding to the user equipment-specific interference measurement resources for the user equipment; and

transmitting comprises transmitting the precoded user equipment-specific channel state information reference signals to the user equipment and transmitting precoded information on the resources corresponding to the user equipment-specific interference measurement resources.

A method as in method 800 and paragraphs referencing method 800, further comprising: coding information based on a precoder selected using the received channel state information; and transmitting the coded information to the user equipment. This is typically a MU-MIMO transmission.

A method as in method 800 and paragraphs referencing method 800, wherein the channel state information comprises one or more of a channel quality indicator or a rank indictor.

A method as in method 800 and paragraphs referencing method 800, wherein configuring further comprises transmitting an information element indicating the restrictions to the user equipment using radio resource control signaling.

A method as in method 800 and paragraphs referencing method 800, where an entire bandwidth is divided into a number of sub-bands, and the restrictions limit use by the user equipment to particular ones of the sub-bands for one or both of the reference signals or the interference measurement resources. The method of this paragraph, wherein configuring further comprises changing the restrictions from one set of sub-bands in a first subframe to a different set of sub-bands in a second subframe.

Another example is an apparatus comprising: means for configuring a user equipment with restrictions that restrict resources carrying reference signals and interference measurement resources to specific resources to be used by the user equipment for determining channel state information. The restrictions are both of the following: first restrictions in time, frequency, or both time and frequency of resources that carry the reference signals; and second restrictions in time, frequency, or both time and frequency of resources that carry the interference measurement resources. The first and second restrictions may be different. The apparatus comprises means for transmitting the reference signals and interference measurement resources to the user equipment and means for receiving from the user equipment the channel state information determined based on the reference signals, interference measurement resources, and the restrictions. An apparatus as in this paragraph, with means for performing any of the methods in the paragraphs referencing method 800.

Additional exemplary embodiments are as follows. An apparatus as in any apparatus above, wherein the restrictions restrict specific resources to one of a set of subcarriers, a set of physical resource blocks, a set of subbands, or a set of sub-frames for one or both of the reference signals or the interference measurement resources. An apparatus as in this paragraph, wherein the specific resources are further restricted to certain resources that occur during a frame.

An apparatus as in any apparatus above, wherein the means for configuring further comprises means for configuring the user equipment to restricting use by the user equipment to the specific resources as a function of sub-frame number and changing the sub-frame number with time.

An apparatus as in any apparatus above, wherein:

the apparatus further comprises:

means for determining a pairing between the user equipment and one or more paired user equipment based on channel state information from the user equipment that was determined from non-user-equipment-specific reference signals and interference measurement resources and from a plurality of other user equipment including the one or more paired user equipment; and

means for precoding, using the determined pairing, user equipment-specific channel state information reference signals based on a precoding weight determined for the user equipment and precoded information to be transmitted on resources corresponding to the user equipment-specific interference measurement resources for the user equipment; and

the means for transmitting comprises means for transmitting the precoded user equipment-specific channel state information reference signals to the user equipment and transmitting precoded information on the resources corresponding to the user equipment-specific interference measurement resources.

An apparatus as in any apparatus above, further comprising: means for coding information based on a precoder selected using the received channel state information; and means for transmitting the coded information to the user equipment. This is typically a MU-MIMO transmission.

An apparatus as in any apparatus above, wherein the channel state information comprises one or more of a channel quality indicator or a rank indictor.

An apparatus as in any apparatus above, wherein the means for configuring further comprises means for transmitting an information element indicating the restrictions to the user equipment using radio resource control signaling.

An apparatus as in any apparatus above, where an entire bandwidth is divided into a number of sub-bands, and the restrictions limit use by the user equipment to particular ones of the sub-bands for one or both of the reference signals or the interference measurement resources. The apparatus of this paragraph, wherein the means for configuring further comprises means for changing the restrictions from one set of sub-bands in a first subframe to a different set of sub-bands in a second sub frame.

Another exemplary embodiment an apparatus that includes one or more processors and one or more memories including computer program code. The one or more memories and the computer program code are configured to, with the one or more processors, cause the apparatus to perform the method 800 or any of the methods in the paragraphs referencing method 800.

FIG. 9 is a logic flow diagram performed by a user equipment for multiple restrictions for CSI reporting. Further, this figure illustrates the operation of an exemplary method, a result of execution of computer program instructions embodied on a computer readable memory, functions performed by logic implemented in hardware, and/or interconnected means for performing functions in accordance with exemplary embodiments. It is assumed the blocks in FIG. 9 are performed by a UE 110, e.g., under control in part of the CSI F/B module 140.

For ease of reference, assume that the flow in FIG. 9 is a method 900. The UE 110 in block 910 performs the operation of configuring a user equipment with restrictions that restrict resources carrying reference signals and interference measurement resources to specific resources to be used by the user equipment for determining channel state information. The restrictions are both of the following: restrictions in time, frequency, or both time and frequency of resources that carry the reference signals (block 915); and restrictions in time, frequency, or both time and frequency of resources that carry the interference measurement resources (block 920). In block 925, the UE 110 performs the operation of receiving from a base station the reference signals and interference measurement resources. The UE 110, in block 930, performs the operation of determining the channel state information based on the specific resources for the reference signals and interference measurement resources, and in block 930, the UE 110 performs the operation of transmitting the channel state information to the base station.

Additional examples are as follows. A method as in method 900, wherein the restrictions restrict specific resources to one of a set of subcarriers, a set of physical resource blocks, a set of subbands, or a set of sub-frames for one or both of the reference signals or the interference measurement resources. A method as in this paragraph, wherein the specific resources are further restricted to certain resources that occur during a frame.

A method as in method 900 and the previous paragraph, wherein:

the method further comprises measuring the received reference signals and measuring power on the received interference measurement resources; and

determining the channel state information further comprises determining the channel state information based on:

the measured received reference signals and the restrictions in time, frequency, or both time and frequency of the resources that carried the reference signals; and

the measured power and the restrictions in time, frequency, or both time and frequency of the resources that carried the measured interference measurement resources.

A method as in method 900 and paragraphs referencing method 900, further comprising: receiving from the base station previously coded information, wherein the previously coded information was coded by the base station based on a precoder selected using the channel state information.

A method as in method 900 and paragraphs referencing method 900, wherein the channel state information comprises one or more of a channel quality indicator or a rank indictor.

A method as in method 900 and paragraphs referencing method 900, wherein configuring further comprises receiving from the base station an information element indicating the restrictions using radio resource control signaling.

A method as in method 900 and paragraphs referencing method 900, where an entire bandwidth is divided into a number of sub-bands, and the restrictions limit use by the user equipment to particular ones of the sub-bands for one or both of the reference signals or the interference measurement resources. A method as in this paragraph, wherein configuring further comprises changing the restrictions from one set of sub-bands in a first subframe to a different set of sub-bands in a second sub frame.

Another example is an apparatus comprising: means for configuring a user equipment with restrictions that restrict resources carrying reference signals and interference measurement resources to specific resources to be used by the user equipment for determining channel state information. The restrictions are both of the following: restrictions in time, frequency, or both time and frequency of resources that carry the reference signals; and restrictions in time, frequency, or both time and frequency of resources that carry the interference measurement resources. The apparatus comprises means for receiving from a base station the reference signals and interference measurement resources, means for determining the channel state information based on the specific resources for the reference signals and interference measurement resources, and means for transmitting the channel state information to the base station. An apparatus as in this paragraph, with means for performing any of the methods in the paragraphs referencing method 900.

Additional examples are as follows. An apparatus as in any of the apparatus above, wherein the restrictions restrict specific resources to one of a set of subcarriers, a set of physical resource blocks, a set of subbands, or a set of sub-frames for one or both of the reference signals or the interference measurement resources. An apparatus as in this paragraph, wherein the specific resources are further restricted to certain resources that occur during a frame.

An apparatus as in any of the apparatus above, wherein:

the apparatus further comprises means for measuring the received reference signals and measuring power on the received interference measurement resources; and

the means for determining the channel state information further comprises means for determining the channel state information based on:

the measured received reference signals and the restrictions in time, frequency, or both time and frequency of the resources that carried the reference signals; and

the measured power and the restrictions in time, frequency, or both time and frequency of the resources that carried the measured interference measurement resources.

An apparatus as in any of the apparatus above, further comprising: means for receiving from the base station previously coded information, wherein the previously coded information was coded by the base station based on a precoder selected using the channel state information.

An apparatus as in any of the apparatus above, wherein the channel state information comprises one or more of a channel quality indicator or a rank indictor.

An apparatus as in any of the apparatus above, wherein the means for configuring further comprises means for receiving from the base station an information element indicating the restrictions using radio resource control signaling.

An apparatus as in any of the apparatus above, where an entire bandwidth is divided into a number of sub-bands, and the restrictions limit use by the user equipment to particular ones of the sub-bands for one or both of the reference signals or the interference measurement resources. An apparatus as in this paragraph, wherein the means for configuring further comprises means for changing the restrictions from one set of sub-bands in a first subframe to a different set of sub-bands in a second subframe.

Another exemplary embodiment an apparatus that includes one or more processors and one or more memories including computer program code. The one or more memories and the computer program code are configured to, with the one or more processors, cause the apparatus to perform the method 900 or any of the methods in the paragraphs referencing method 900.

A system comprises any of the apparatus referring to method 800 and any of the apparatus referring to method 900.

An additional exemplary embodiment includes a computer program, comprising code for performing the methods 800 or 900 or any methods referring to methods 800 or 900, when the computer program is run on a processor. The computer program according to this paragraph, wherein the computer program is a computer program product comprising a computer-readable medium bearing computer program code embodied therein for use with a computer.

Exemplary advantages and technical effects of various embodiments include the following non-limiting and non-exhaustive examples:

1. There is improvement of link adaption for reciprocity-based operation by enabling feedback of post beamforming CQI.

2. There is improvement of link adaption for MU-MIMO by enabling accurate estimation of interference from co-scheduled UEs.

3. Existing methods of CSI feedback from LTE-A are built on with legacy support.

4. There is overhead reduction for the resources needed for CSI-RS and IMR.

The various controllers/data processors, memories, programs, transceivers and antenna arrays depicted in FIG. 1 may all be considered to represent means for performing operations and functions that implement the several non-limiting aspects and embodiments of this invention.

At least some embodiments herein may be implemented in software (executed by one or more processors), hardware (e.g., an application specific integrated circuit), or a combination of software and hardware. In an example of an embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain or store the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

3D-MIMO three-dimensional-MIMO

3GPP third-generation partnership project

5G fifth generation

ABS almost-blank subframe

CSI channel state information

CSI-RS channel state information-reference signal

CQI channel quality indicator

eICIC enhanced inter-cell interference coordination

eNB evolved NodeB (e.g., an LTE base station)

FD-MIMO full dimension-MIMO

FDM frequency-division multiplexing

HetNet heterogeneous network

IMR interference measurement resource

LTE long term evolution

LTE-A LTE-advanced

MCS modulation and coding scheme

MIMO multiple input, multiple output

ms milliseconds

MU-MIMO multi-user MIMO

PMI precoding matrix indicator

PRB physical resource block

RAN radio access network

RE resource element

Rel release

RI rank indicator

RRC radio resource control

RS reference signal

Rx reception or receiver

TDD time-division duplex

TSG technical specification group

Tx transmission or transmitter

UE user equipment (e.g., a wireless device)

WG working group

1. A method, comprising:
configuring a user equipment with restrictions that restrict resources carrying reference signals and interference measurement resources to specific resources to be used by the user equipment for determining channel state information, wherein the restrictions are both of the following:
first restrictions in time, frequency, or both time and frequency of resources that carry the reference signals; and
second restrictions in time, frequency, or both time and frequency of resources that carry the interference measurement resources;
transmitting the reference signals and interference measurement resources to the user equipment; and
receiving from the user equipment the channel state information determined based on the reference signals, interference measurement resources, and the restrictions.

2.-10. (canceled)

11. An apparatus, comprising:
one or more processors; and
one or more memories including computer program code,
the one or more memories and the computer program code configured, with the one or more processors, to cause the apparatus to perform at least the following:
configuring a user equipment with restrictions that restrict resources carrying reference signals and interference measurement resources to specific resources to be used by the user equipment for determining channel state information, wherein the restrictions are both of the following:
first restrictions in time, frequency, or both time and frequency of resources that carry the reference signals; and
second restrictions in time, frequency, or both time and frequency of resources that carry the interference measurement resources;
transmitting the reference signals and interference measurement resources to the user equipment; and
receiving from the user equipment the channel state information determined based on the reference signals, interference measurement resources, and the restrictions.

12. The apparatus of claim 11, wherein the restrictions restrict specific resources to one of a set of subcarriers, a set of physical resource blocks, a set of subbands, or a set of sub-frames for one or both of the reference signals or the interference measurement resources.

13. The apparatus of claim 12, wherein the specific resources are further restricted to certain resources that occur during a frame.

14. The apparatus of claim 11, wherein the configuring further comprises configuring the user equipment to restricting use by the user equipment to the specific resources as a function of sub-frame number and changing the sub-frame number with time.

15. The apparatus of claim 11, wherein:
the one or more memories and the computer program code are further configured, with the one or more processors, to cause the apparatus to perform at least the following:
determining a pairing between the user equipment and one or more paired user equipment based on channel state information from the user equipment that was determined from non-user-equipment-specific reference signals and interference measurement resources and from a plurality of other user equipment including the one or more paired user equipment;
precoding, using the determined pairing, user equipment-specific channel state information reference signals based on a precoding weight determined for the user equipment and precoded information to be transmitted on resources corresponding to the user equipment-specific interference measurement resources for the user equipment; and
transmitting comprises transmitting the precoded user equipment-specific channel state information reference signals to the user equipment and transmitting precoded information on the resources corresponding to the user equipment-specific interference measurement resources.

16. The apparatus of claim 11, the one or more memories and the computer program code are further configured, with the one or more processors, to cause the apparatus to perform at least the following:
coding information based on a precoder selected using the received channel state information; and
transmitting the coded information to the user equipment.

17. The apparatus of claim 11, wherein the channel state information comprises one or more of a channel quality indicator or a rank indictor.

18. The apparatus of claim 11, wherein configuring further comprises transmitting an information element indicating the restrictions to the user equipment using radio resource control signaling.

19. The apparatus of claim 11, where an entire bandwidth is divided into a number of sub-bands, and the restrictions limit use by the user equipment to particular ones of the sub-bands for one or both of the reference signals or the interference measurement resources.

20. The apparatus of claim 19, wherein configuring further comprises changing the restrictions from one set of sub-bands in a first subframe to a different set of sub-bands in a second subframe.

21.-29. (canceled)

30. An apparatus, comprising:
one or more processors; and
one or more memories including computer program code,
the one or more memories and the computer program code configured, with the one or more processors, to cause the apparatus to perform at least the following:
configuring a user equipment with restrictions that restrict resources carrying reference signals and interference measurement resources to specific resources to be used by the user equipment for determining channel state information, wherein the restrictions are both of the following:
first restrictions in time, frequency, or both time and frequency of resources that carry the reference signals; and
second restrictions in time, frequency, or both time and frequency of resources that carry the interference measurement resources; and
receiving from a base station the reference signals and interference measurement resources;
determining the channel state information based on the specific resources for the reference signals and interference measurement resources; and
transmitting the channel state information to the base station.

31. The apparatus of claim 30, wherein the restrictions restrict specific resources to one of a set of subcarriers, a set of physical resource blocks, a set of subbands, or a set of sub-frames for one or both of the reference signals or the interference measurement resources.

32. The apparatus of claim 31, wherein the specific resources are further restricted to certain resources that occur during a frame.

33. The apparatus of claim 30, wherein:
the one or more memories and the computer program code are further configured, with the one or more processors, to cause the apparatus to perform at least the following: measuring the received reference signals and measuring power on the received interference measurement resources; and
determining the channel state information further comprises determining the channel state information based on:
the measured received reference signals and the restrictions in time, frequency, or both time and frequency of the resources that carried the reference signals; and
the measured power and the restrictions in time, frequency, or both time and frequency of the resources that carried the measured interference measurement resources.

34. The apparatus of claim 30, the one or more memories and the computer program code are further configured, with the one or more processors, to cause the apparatus to perform at least the following:
receiving from the base station previously coded information, wherein the previously coded information was coded by the base station based on a precoder selected using the channel state information.

35. The apparatus of claim 30, wherein the channel state information comprises one or more of a channel quality indicator or a rank indictor.

36. The apparatus of claim 30, wherein configuring further comprises receiving from the base station an information element indicating the restrictions using radio resource control signaling.

37. The apparatus of claim 30, where an entire bandwidth is divided into a number of sub-bands, and the restrictions limit use by the user equipment to particular ones of the sub-bands for one or both of the reference signals or the interference measurement resources.

38. The apparatus of claim 37, wherein configuring further comprises changing the restrictions from one set of sub-bands in a first subframe to a different set of sub-bands in a second subframe.
